(19) United States
(12) Patent Application Publication
(10) Pub. No.: US 2006/0249531 A1
(43) Pub. Date: Nov. 9, 2006

(54) Motion Activated Food Dispenser

(76) Inventor: Richard J. Litchfield, Hopkinton, MA (US)

Correspondence Address: STAINBROOK & STAINBROOK, LLP, 3558 ROUND BARN BLVD., SUITE 203, SANTA ROSA, CA, 95403, US

(21) Appl. No.: 11/382,425

(22) Filed: May 9, 2006

Related U.S. Application Data
(60) Provisional application No. 60/678,980, filed on May 9, 2005.

(51) Int. Cl. B67D 5/08

(52) U.S. Cl. 222/52; 222/370; 222/363

(57) ABSTRACT

A motion activated food dispenser having a housing with a food dispensing outlet, means for controlling and directing the discharge of food product from the dispensing outlet when a receptacle is placed suitably near the discharge outlet, an electrically driven dispenser door in the interior space of said housing, a motion sensor, control electronics electronically connected to said motion sensor, and a control circuit electrically connected to the electric motor and the control electronics.

### CROSS REFERENCES TO RELATED APPLICATIONS

The present application claims the benefit of U.S. Provisional Patent Application Ser. No. 60/678,980, filed May 09, 2005 (May 9, 2005).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to food vending machines and automatic dispensing machines, and more particularly to a motion activated dispenser for particulate food products.

2. Discussion of Related Art including information disclosed under 37 CFR §§1.97, 1.98:

There are a few well-established apparatus employed to dispense particulate food or articles from commercial vending machines. Currently, the most popular machine is a food vending machine which contains and displays a number of packaged food products, including particulate candy or snacks contained in bulk packaging. The food package is dispensed upon insertion of coin or paper money in the correct amount and then selection of the desired package (identified numerically or alphanumerically) by pressing a corresponding button on a button console.

A popular classic apparatus is the gumball machine. This antiquated drugstore mainstay is so cumbersome relative to its contemporary machines and so conspicuously inefficient as to be slightly amusing to operate. It commonly includes a spherical or cylindrical gumball container at the bottom of which is a cup integrated into a crank which is unlocked for rotation when the appropriate coins are put into the machine. A crank handle is then turned, typically 90 degrees, to dump the contents of the cup (gum, candy pieces, etc.) into the customer's hand or into a small receptacle from which the user scoops out the product. Turning the handle loads a spring which returns the crank to its starting position after the product has been dispensed. It is generally a two-handed operation and even requires a measure of both dexterity and strength.

The above-described exemplary dispensing and vending machines, as well as numerous common variants, have several drawbacks, most important of which is that use of the machines involves considerable manual manipulation, and users may leave transmissible pathogens on any surfaces touched by their fingers and hands. Furthermore, such machines dispense only small amounts of product and/or product limited in amount by its packaging. Packaging is notoriously wasteful of paper and other resources.

Several of the drawbacks of commercial vending machines are also characteristic of residential devices employed to contain and dispense particulate food product. Generally speaking, a consumer typically places small comestibles in a container or bowl, and the food is not so much dispensed as it is simply retrieved by reaching into the bowl or container, either with the hand or with a utensil, and taking out the desired amount. It will be readily appreciated that this is a perfect means for transmitting germs from one user to the next. Additionally, it often makes for messes as eager hands pull food pieces up and over a container edge for grasping and collecting in the fingers and hand.

A few devices have been proposed to solve the foregoing problems. Among the exemplary solutions are the following US patents.

U.S. Pat. Appl. Pub. No. 2004/0226962, by Mazursky, discloses a free-standing or wall-mounted dispenser and system for automatically dispensing liquid. The dispenser generates an infrared signal in the proximity of the dispenser's spigot. A user's hand, or other object, intersects the infrared signal and causes the unit to dispense liquid. The dispenser utilizes a DC power source, and includes an on-off switch, which can be switched off for refilling, moving or cleaning the dispenser, and prolonging battery life. A disposable liquid cartridge in the form of a bag or bottle with a valve can be incorporated into the system, together with a master switch disabling the dispenser until an acceptable keyed cartridge is properly inserted.

U.S. Pat. Appl. Ser. No. 2002/0175182, by Matthews, a user monitoring system for use in association with soap dispensers. The monitoring system includes a sensing system, a user identification system and data storage. The sensing system is for sensing a user. The user identification system is operably connected to and responsive to the sensing system for identifying a unique user whereby the user identification system is activated once the sensing system has sensed a user. The data storage is operably connected to the user identification system and is for recording the unique user. The user monitoring system may be connected to an automatic dispenser that dispenses liquid responsive to a signal from the sensing system.

U.S. Pat. No. 5,329,117, to Galili et al., shows a dosing dispenser for flowable material, including a container having an outlet through which material can pass by gravity, an electrically operated valve having a nozzle coupled to the outlet for controlling the passage of material through the outlet, an electromagnetic radiation emitter located in close proximity to the nozzle, for emitting a controlled radiation beam in the vicinity of the nozzle, and an electromagnetic radiation detector located adjacent to the emitter and responsive to radiation emitted from the emitter and reflected by a hand placed in the radiation path. The emitter and detector are affixed in a radiation directing and shielding housing, for determining the directivity of the emitted and reflected radiation. There is also provided an electronic control circuit for controlling the valve in response to detected radiation reflected by the body placed along the emitted radiation path.

U.S. Pat. No. 6,279,777, to Goodin et al., teaches a system for controlling the operation of a dispensing device in response to the presence of a human hand. It includes a device for detecting the presence of a hand in an area and producing a first output signal in response to the detection. A second sensor separately detects the presence of a hand in the area and produces a second output signal in response to the separate detection. A processor determines the presence of both the first and second output signals and in response provides a control signal to the dispensing device.

Other notable references include: U.S. Pat. No. 5,975,366, teaching a device for dispensing powdered or particulate materials in side-by-side compartments; U.S. Pat. No. 4,776,489, showing an automatic spice and herb dispenser; U.S. Pat. No. 5,771,778, which discloses an aroma emitting display apparatus responsive to the presence of a person; and U.S. Pat. No. 6,273,027, which illustrates an animal training device that delivers rewards automatically in response to a detected desired behavior.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention is an improved motion activated food dispenser for dispensing a pre-measured portion of particulate food product when a hand, cup, or bowl is placed below the dispensing outlet. This provides a hands free, sanitary and entertaining way to dispense snacks, cereals, grains, nuts, dietary supplements in pill form, vitamins, and the like.

It is therefore an object of the present invention to provide a new and improved motion activated food dispenser.

It is another object of the present invention to provide a new and improved motion activated food dispenser that prevents transmission of communicable disease.

A further object or feature of the present invention is a new and improved motion activated food dispenser that is entertaining to operate.

An even further object of the present invention is to provide a novel motion activated food dispenser that dispenses a predetermined amount of particulate food product without the need of packaging for the food.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of the motion activated food dispenser of the present invention;

FIG. 2 is a front view in elevation thereof;

FIG. 3 is a partial cross-sectional side view in elevation taken along section lines 3-3 of FIG. 2;

FIG. 4 is a top plan view showing detail of the dispensing door mechanism as taken along the section lines 4-4 of FIG. 3;

FIG. 5 is a front perspective view of a second preferred embodiment of the inventive apparatus;

FIG. 6 shows the apparatus of FIG. 5 in use;

FIGS. 7A and 7B are, respectively, cross-sectional side views in elevation showing the second preferred embodiment in the storage configuration and in the dispensing configuration; and

FIG. 8 is a schematic view of the apparatus electronics.

### DRAWING LEGEND

110 housing

120 upper portion of housing

122 top of upper portion of housing

124 bottom of upper portion of housing

126 side wall of upper portion of

130 base portion of housing

132 arcuate foot of base portion

134 concavity in arcuate foot

136 dispensing area

140 interior food container space

150 lid

160 window in upper portion of housing

170 a food dispensing outlet

180 underside of bottom 124

190 chute

200 dispenser door

205 axle

210 floor of upper portion

220 circumferential gear teeth on dispenser door

230 gear

240 drive shaft

250 electric motor

260 battery

270 openings in dispenser door

275 dispensing outlet opening

280 motion sensor

290 interior side

300 control electronics

310 cam switch

320 control circuit

400 box for second preferred embodiment

410 hopper

415 opening in hopper floor

420 upper portion

425 hopper floor

430 dispensing chamber

440 lower portion

450 outlet tube

460 food

470 lower opening

480 dispensing sphere

490 axle

500 receptacle

510 handle portion

### DETAILED DESCRIPTION OF THE INVENTION

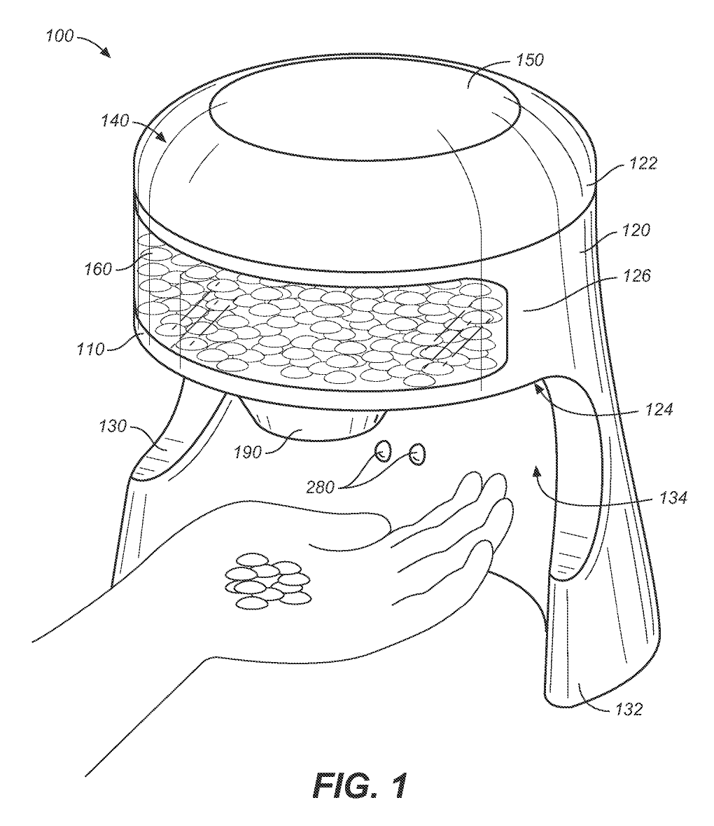

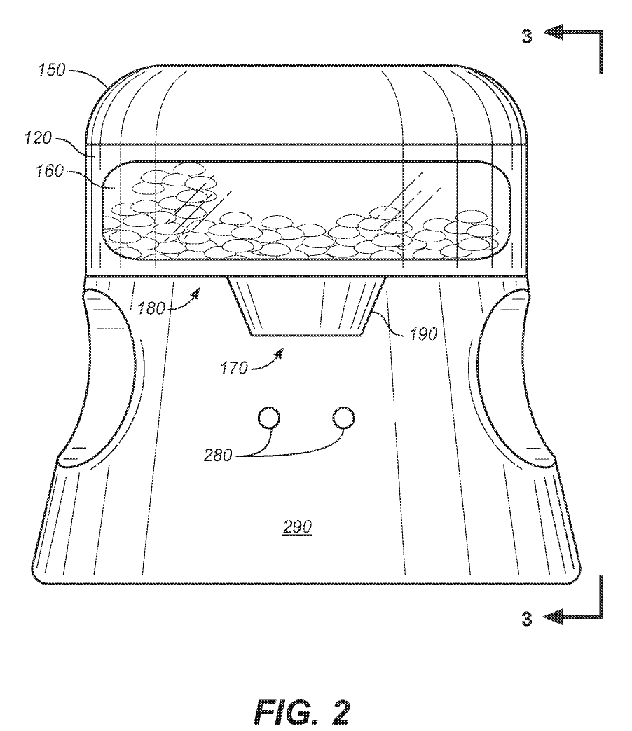

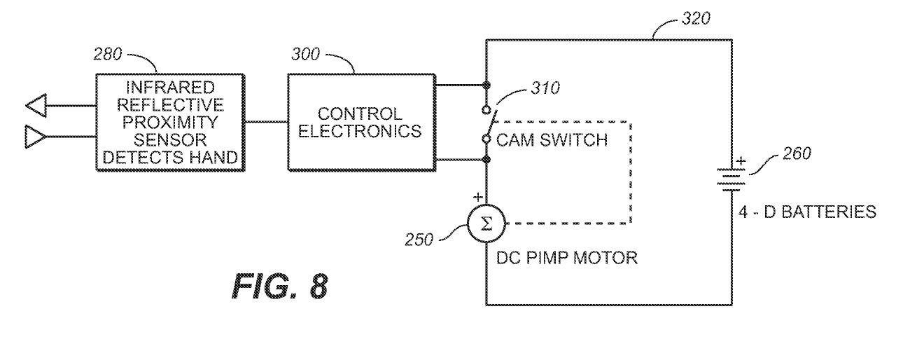

Referring to FIGS. 1 through 8, wherein like reference numerals refer to like components in the various views, there is illustrated therein a new and improved motion activated food dispenser, generally denominated 100 herein.

FIGS. 1 through 3 illustrate a first preferred embodiment of the inventive motion activated food dispenser, showing that the apparatus comprises a housing 110, which is preferably a unitary molded or formed plastic article adapted in size and design for placement on a counter top. The housing includes an upper portion 120 and base portion 130, which preferably includes an arcuate foot 132 and which defines a concavity 134 which partially protects the dispensing area 136 of the apparatus. The upper portion includes a top 122, a 124, and a side walls 126, which defines an interior food container space 140, which functions as a food reservoir or hopper for the storage of particulate food product. A removable or hinged lid 150 provides access to the interior space for filling the dispenser. The lid may be threadably screwed onto the upper portion of the housing, or it may be insertably coupled with an annular surface that inserts into the inner circumference of the upper portion; it may also be mounted with a tongue-and-slot, bayonet type of coupling, or it may simply be hinged. If it is insertably coupled to the upper portion, it may be provided with sealing means, such as an O-ring, so that once the lid is placed onto the housing, it is a substantially airtight seal, thus preventing food spoilage.

In the first preferred embodiment, the upper portion of the housing includes a window 160 for viewing the contents of the food reservoir.

A food dispensing outlet 170 is disposed on the underside 180 of the bottom 124 of the upper portion 120 of the housing. Immediately underneath the dispensing outlet is a chute or funnel 190 to assist in the controlled discharge of food product.

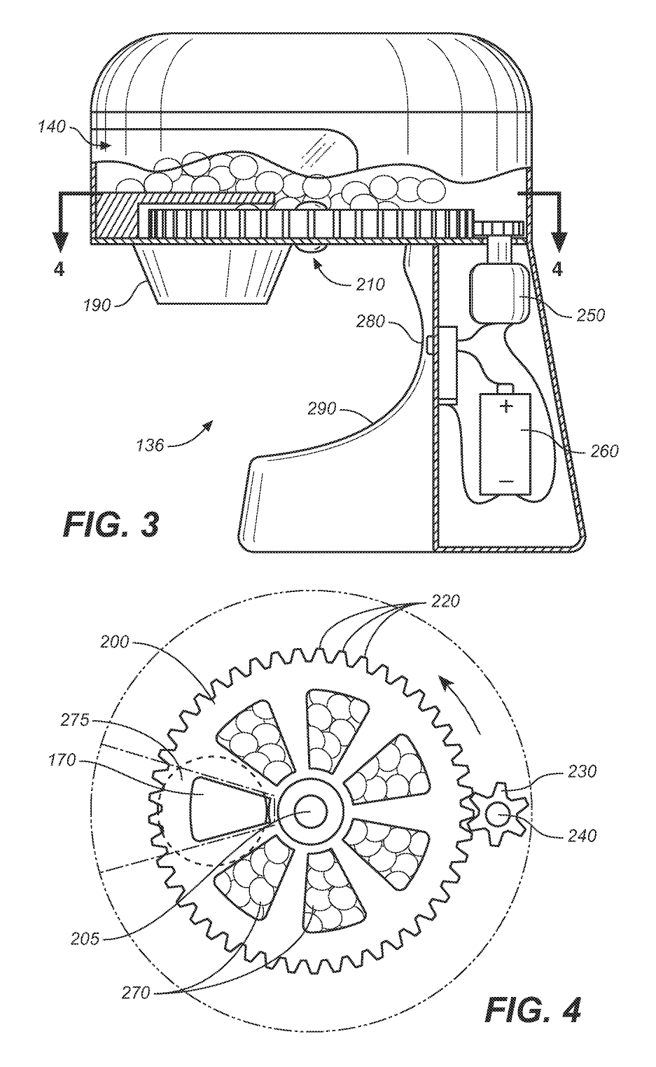

Referring now to FIGS. 3 and 4, a gear driven dispenser door 200 is disposed within the interior space and is rotatably mounted on an axle 205 positioned vertically in the floor 210 of the upper portion. In a first preferred embodiment the dispensing door comprises a wheel having circumferential gear teeth 220 in mesh with a gear 230 axially disposed on a drive shaft 240 of an electric motor 250 powered by a battery 260. The drive shaft, electric motor, and battery are enclosed within the base portion of the housing. The dispensing door includes a plurality of openings 270 which are brought into alignment with the dispensing outlet opening 275 as the wheel turns.

Referring now especially to FIGS. 3, 7A, and 8, a motion sensor 280, preferably an infrared reflective proximity sensor, is positioned on the interior side 290 of the base portion and in proximity to the dispensing outlet. When a suitable receptacle, such as a hand, bowl, cup, or other container device is placed near the sensor, the IR signal from the sensor is reflected and detected in a well-known manner, causing a signal to be sent to the control electronics 300, which closes cam switch 310 and thus control circuit 320. The electric motor 250 actuated by closing the control circuit operates for either a predetermined time (so as to dispense a metered amount) or for only as long as the user's hands and/or a container are in sufficient proximity to the motion sensor.

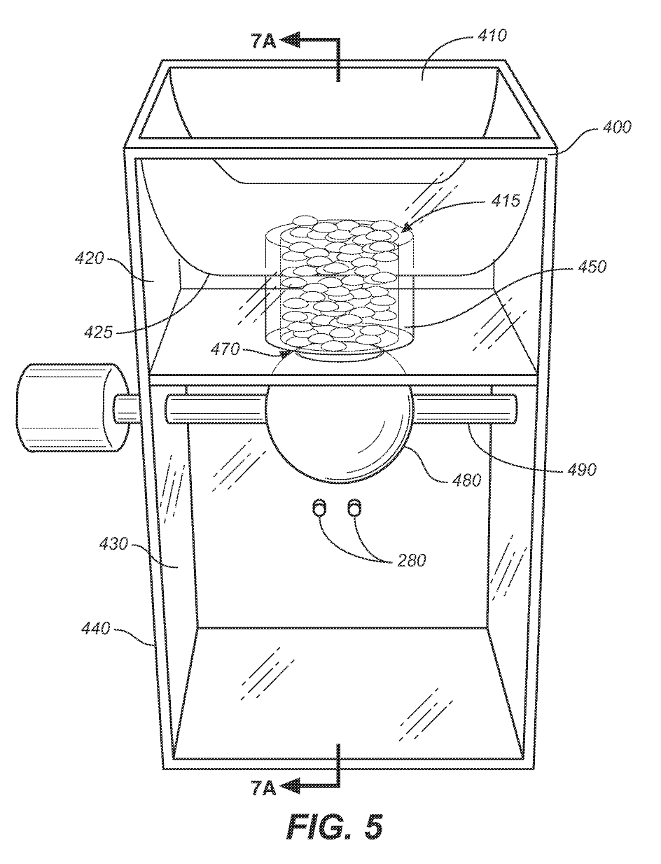

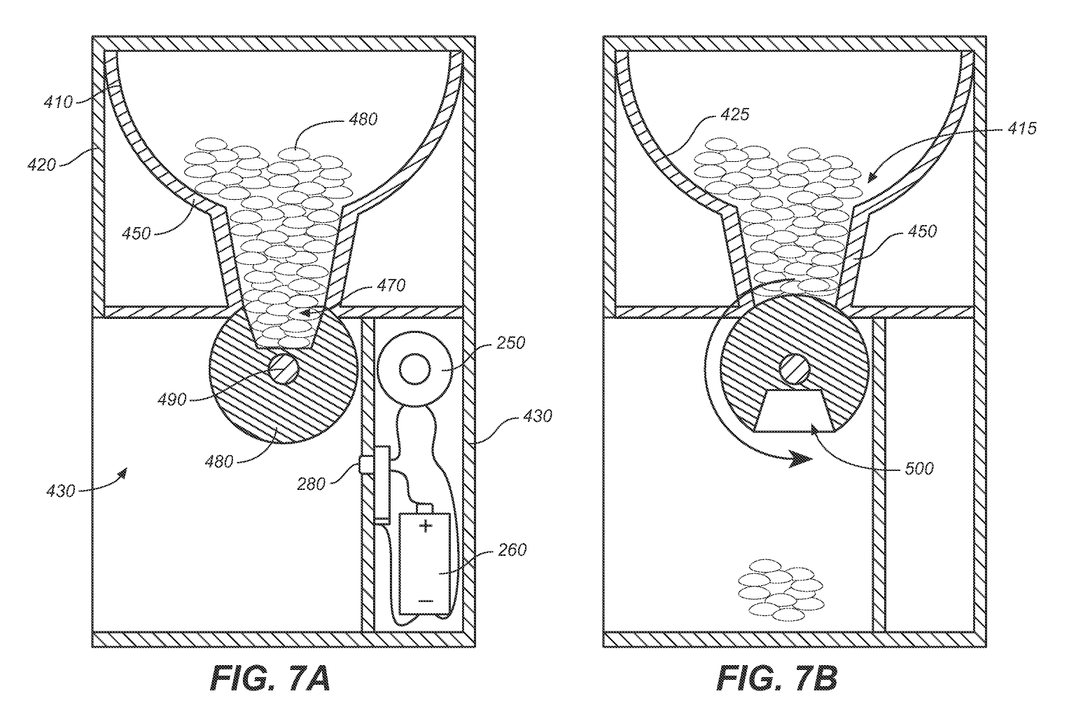

FIGS. 5 through 7B show a second preferred embodiment of the motion activated food dispenser of the present invention. In this embodiment, the apparatus comprises a cuboid box 400 having a hopper 410 in its upper portion 420 and a dispensing chamber 430 in a lower portion 440. The hopper includes an outlet tube 450 having an upper opening 415 in the hopper floor 425 that funnels particulate food 460 down to a lower opening 470 and into or onto a dispensing sphere 480 or cylinder mounted on an axle 490 and having a receptacle 500 that is rotated into alignment with the opening 470 to accept and retain a pre-measured portion of food. When actuated by the electronics and motor unit of the apparatus, the axle 490 and sphere 480 rotate to a substantially inverted orientation to dispense any food that has been funneled into the receptacle [FIG. 7B]. It is then returned to a loading position [FIG. 7A].

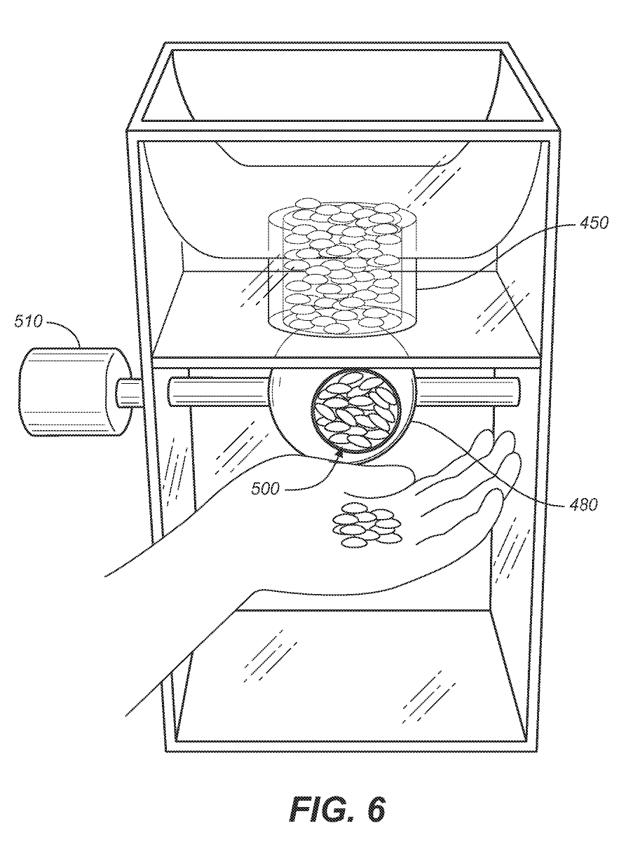

If desired, the sensor and motor can be disabled and manual operation of the device can be accomplished by using a handle portion 510 of the axle [FIG. 6].

Thus, in its most essential aspect, the motion activated food dispenser of the present invention will be seen to comprise a food container having an outlet, a selectively operable door which may be opened to discharge food product or closed to retain food product; an electric motor which opens and closes the door; a sensor or sensors connected to the electric motor for sensing when hands or another receptacle is brought into sufficient proximity with the outlet in the food container, and control means electronically connected to the electric motor and the sensing means for controlling the time frames in which the electric motor operates to open and close the door.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A motion activated food dispensing apparatus, comprising:
a food container having an outlet through which particulate food product is discharged;
a door which may be selectively opened to discharge food product and closed to retain food product;
an electric motor operatively connected to said door for opening and closing said door;
sensing means electronically connected to said electric motor and said sensing means for sensing when a receptacle is brought into sufficient proximity with the outlet in said food container;
control means electronically connected to said electric motor and said sensing means, said control means for controlling the time frames in which said electric motor operates to open and close said door.

2. A motion activated food dispensing apparatus, comprising:
a food container housing having an upper portion and a base portion, said upper portion including a top, a bottom having a food dispensing outlet, and a side wall defining an interior space to hold particulate food product;
a lid disposed on said upper portion top and providing access to the interior space in said housing;
a food dispensing outlet;
discharge means for controlling and directing the discharge of food product from the dispensing outlet when a suitable receptacle is placed underneath said discharge means;
a dispenser door disposed within the interior space of said housing, an electric motor operatively connected to said dispenser door to selectively open door to permit the discharge of particulate food product from said housing;
a motion sensor positioned on said interior side of said base portion;
control electronics electronically connected to said motion sensor; and
a control circuit electrically connected to said electric motor and said control electronics;
whereby when a receptacle is placed near said motion sensor, a signal is caused to be sent to said control electronics, which closes said control circuit and turns on said electric motor to open said dispenser door.

3. The apparatus of claim 2, wherein said upper portion of said housing is a hopper shaped to feed particulate food product into its outlet

4. The apparatus of claim 2, wherein said base portion is arcuate.

5. The apparatus of claim 2, wherein said housing top is removably attached to said upper portion of said housing by connection means selected from the group consisting of matable threaded screws, tongue-and-slot connector, bayonet coupling, and hinges.

6. The apparatus of claim 5, wherein said connection means provides an airtight seal to prevent food spoilage.

7. The apparatus of claim 2, further including a window disposed in said upper portion of said housing includes for viewing any food contained in said food container

8. The apparatus of claim 2, wherein said upper portion includes an underside and said product outlet is disposed on said underside of said housing.

9. The apparatus of claim 2, wherein said discharge means comprises a chute positioned underneath the dispensing outlet.

10. The apparatus of claim 10, wherein said dispenser door is a wheel having at least one opening and circumferential gear teeth, and wherein said electric motor includes a gear in mesh with said circumferential gear teeth of said wheel.

11. The apparatus of claim 10, wherein said wheel is rotatably mounted on an axle positioned vertically in said floor of said upper portion.

12. The apparatus of claim 11 where said wheel includes a plurality of openings which are brought into alignment with the dispensing outlet opening as said wheel turns.

13. The apparatus of claim 2, wherein said motion sensor is an infrared reflective proximity sensor.

14. The apparatus of claim 2, wherein said base portion has an interior side and said motion sensor is disposed on said interior side.

15. The apparatus of claim 2, wherein when actuated, said electric motor operates for a predetermined time and dispenses a metered amount determined by the predetermined time.

16. A motion activated particulate food dispenser, comprising:
a box having an upper portion and a lower portion;
a hopper disposed in said upper portion, said hopper having a floor;
a dispensing chamber disposed below said hopper;
an outlet tube connected to said hopper and having an upper opening in said floor of said hopper and a lower opening;
an axle,
a dispensing body rotatably mounted on said axle, said dispensing body having a receptacle portion that may be rotatably brought into alignment with the lower opening in said outlet tube so as to accept and retain a pre-measured portion of food discharged from said hopper;
an electric motor having a drive shaft operatively coupled to said axle;
a motion sensor for sensing the presence of an object in the discharge chamber;
electronics electrically connected to said motion sensor and to said electric motor, whereby when actuated by said electronics, said electric motor drives said axle and said dispensing body into a substantially inverted orientation to dispense any food that has been funneled into the receptacle of said dispensing body.

17. The apparatus of claim 16, further including manual override means, wherein the electric motor may be disabled and said discharging body may be rotated into selective alignment with the upper and lower openings in said outlet tube.
